(19) United States
(12) Patent Application Publication
(10) Pub. No.: US 2023/0199000 A1
(43) Pub. Date: Jun. 22, 2023

(54) AUTHENTICATION AND ACCESS CONTROL FOR REMOTE SUPPORT SYSTEM

(71) Applicant: Dell Products L.P., Round Rock, TX (US)

(72) Inventors: Kai CHEN, Shanghai (CN); Jim Lewei JI, Shanghai City (CN); Bo WANG, Shanghai (CN); Muzhar S. KHOKHAR, Shrewsbury, MA (US)

(73) Assignee: Dell Products L.P., Round Rock, TX (US)

(21) Appl. No.: 17/557,985

(22) Filed: Dec. 21, 2021

(51) Int. Cl. H04L 9/40

(52) U.S. Cl. CPC H04L 63/108; H04L 63/105; H04L 63/08

(57) ABSTRACT

An information handling system may include at least one processor and a memory. The information handling system may be configured to provide access to a target information handling system by: transmitting a request for support to an external support information handling system; receiving, from the external support information handling system, a request for access; and in response to the request for access, transmitting an access token to the external support information handling system, wherein the access token is usable to remotely operate the target information handling system without transmission of account credentials to the external support information handling system.

### TECHNICAL FIELD

The present disclosure relates in general to information handling systems, and more particularly to providing authentication and access control in remote support systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), remote support systems are sometimes used to allow a manufacturer to access systems in a customer datacenter to provide technical assistance. For purposes of this disclosure, the term “manufacturer” may be used broadly to refer to original equipment manufacturers (OEMs), customizers, retailers, wholesalers, and the like.

Currently, if a customer requires remote technical support, the customer generally must provide high-level authentication credentials (e.g., a root or administrator password) to the manufacturer so that manufacturer support personnel can access the customer's systems and make appropriate changes.

However, many customers feel uncomfortable providing sensitive credentials to support engineers. Customers thus often want to audit all accesses by the support engineers, and they typically also reset the root or administrator account passwords after the remote support session is completed. It would be preferable if the remote support engineer could provide support without needing such credentials in the first place.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with authentication and access control in remote support systems may be reduced or eliminated.

In accordance with embodiments of the present disclosure, an information handling system may include at least one processor and a memory. The information handling system may be configured to provide access to a target information handling system by: transmitting a request for support to an external support information handling system; receiving, from the external support information handling system, a request for access; and in response to the request for access, transmitting an access token to the external support information handling system, wherein the access token is usable to remotely operate the target information handling system without transmission of account credentials to the external support information handling system.

In accordance with these and other embodiments of the present disclosure, a method for providing access to a target information handling system may include: transmitting a request for support to an external support information handling system; receiving, from the external support information handling system, a request for access; and in response to the request for access, transmitting an access token to the external support information handling system, wherein the access token is usable to remotely operate the target information handling system without transmission of account credentials to the external support information handling system.

In accordance with these and other embodiments of the present disclosure, an article of manufacture may include a non-transitory, computer-readable medium having computer-executable instructions thereon that are executable by a processor of an information handling system for providing access to a target information handling system by: transmitting a request for support to an external support information handling system; receiving, from the external support information handling system, a request for access; and in response to the request for access, transmitting an access token to the external support information handling system, wherein the access token is usable to remotely operate the target information handling system without transmission of account credentials to the external support information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of an example architecture, in accordance with embodiments of the present disclosure.

### DETAILED DESCRIPTION

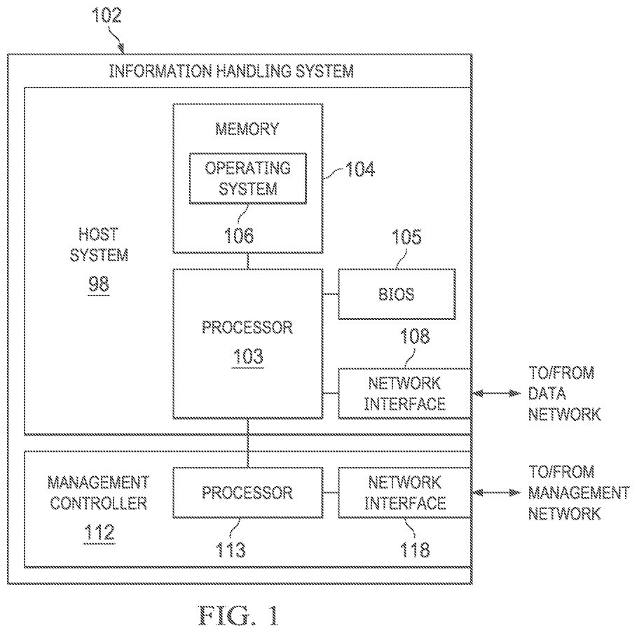

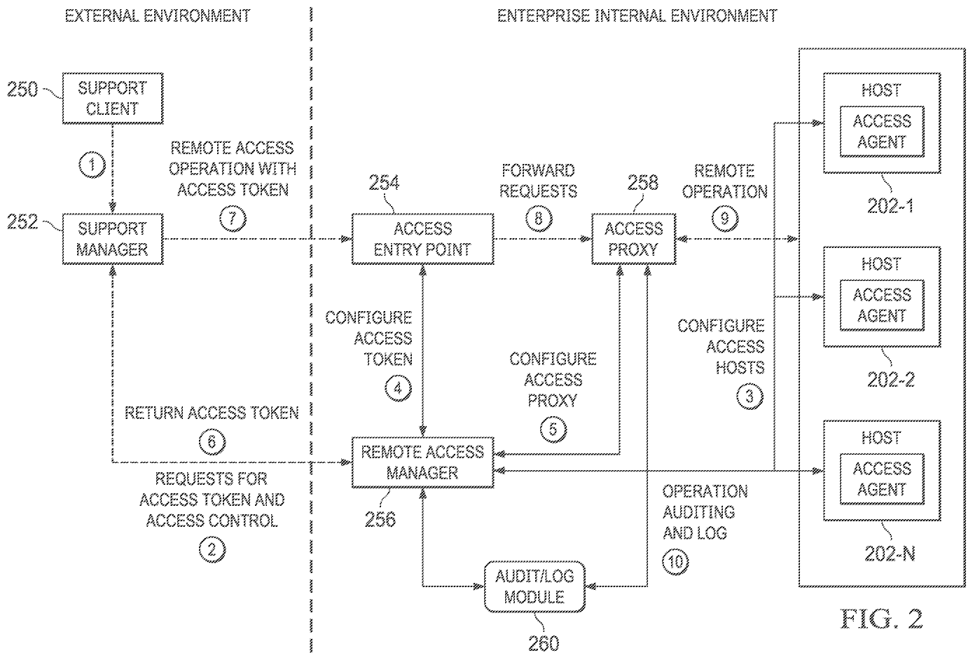

Preferred embodiments and their advantages are best understood by reference to FIGS. 1 and 2, wherein like numbers are used to indicate like and corresponding parts. For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide ways for remote support engineers to access a customer's information handling systems without requiring disclosure of credentials such as root or administrator passwords.

Turning now to FIG. 2, one example of an architecture is shown for implementing an embodiment. In this example, a customer datacenter includes hosts 202-1 through 202-N (collectively, “hosts 202”). An external support engineer (e.g., from a manufacturer of hosts 202) operates support client 250 and needs to access one or more of hosts 202 in order to provide technical support.

As shown in FIG. 2, the external environment may also include a support manager 252, which may be used to coordinate support requests for a plurality of different customers' datacenters and a plurality of support clients 250. The enterprise internal environment at the customer datacenter may also include an access entry point 254, a remote access manager 256, an access proxy 258, and an audit/log module 260. These various components shown in FIG. 2 may be implemented via software, hardware, and/or firmware in particular embodiments. Access entry point 254, remote access manager 256, access proxy 258, and audit/log module 260 may be implemented on a single information handling system within the customer datacenter in one embodiment, or they may be implemented on multiple information handling systems in another embodiment. In one embodiment, they may be implemented via one or more virtual machines, or they may be implemented on bare metal in another embodiment.

In one implementation, the customer may open a remote support ticket to provide information to the manufacturer about an issue and request technical assistance, and the ticket may be transmitted to a support engineer at support client 250. The support engineer may use support client 250 to review support cases, request follow-up information, and access the customer environment. As shown at step 1, support client 250 may communicatively couple to support manager 252 and request access to the customer environment.

As shown at step 2, support manager 252 may transmit a request for an access token and related access control to remote access manager 256. Remote access manager 256 may then generate an access token for the related environment. For example, a time-based Lightweight Directory Access Protocol (LDAP) token, a JavaScript Web Token (JWT), or any other suitable type of access token may be generated to provide access to the desired host(s) 202 for support. For example, the token may define which one(s) of hosts 202 are to be accessible by the support engineer, limited time periods during which access is to be enabled, etc. In various embodiments, the target host(s) 202 which are to be accessed may be entirely separate systems, or they may be elements of an HCI cluster, or they may be different hosts disposed within a single rack, etc.

Remote access manager 256 may then deploy a controlled access entry point 254 for the support engineer to use to access the internal host 202 with the generated access token. Access entry point 254 may be configured to accept external connections from outside the internal datacenter environment. As shown at step 4, remote access manager 256 may configure access entry point 254 with the access token, such that inbound communications that include the access token will be granted access.

As shown at step 5, remote access manager 256 may configure an access proxy 258 to register and authorize the access entry point 254 with related protocols and information regarding the hosts 202 that are to be accessed.

As shown at step 6, remote access manager 256 may return the access token to support manager 252, as well as information (e.g., an IP address or other suitable information) regarding the access entry point 254 which is to be used for providing support.

As shown at step 7, the support engineer may then use the access token to request, via access entry point 254, access to one or more of hosts 202. At step 8, access entry point 254 may forward such request to access proxy 258, which may at step 9 allow remote operation of hosts 202. As shown at step 10, all of the accesses and operations performed by the support engineer may be logged for auditing purposes. Once the support event is completed, the access token may be revoked in some embodiments, such that further attempts to access hosts 202 via that access token are not allowed. In other embodiments, the access token may be time-limited such that revocation is automatic after a selected period of time has elapsed.

Thus, based on the access token and architecture of FIG. 2, the support engineer may provide the requested technical assistance without disclosure of any sensitive access credentials.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to provide access to a target information handling system by:
transmitting a request for support to an external support information handling system;
receiving, from the external support information handling system, a request for access; and
in response to the request for access, transmitting an access token to the external support information handling system, wherein the access token is usable to remotely operate the target information handling system without transmission of account credentials to the external support information handling system.

2. The information handling system of claim 1, wherein the information handling system is the target information handling system.

3. The information handling system of claim 1, wherein the access token specifies the target information handling system as one of a plurality of potential target information handling systems.

4. The information handling system of claim 1, wherein the access token specifies a period of time during which access is granted.

5. The information handling system of claim 1, further configured to, in response to an indication that the remote operation of the target information handling system has ended, cause the access token to be revoked.

6. The information handling system of claim 1, wherein remotely operating the target information handling system includes performing a task that requires administrator-level access to the target information handling system.

7. A method for providing access to a target information handling system, the method comprising:
transmitting a request for support to an external support information handling system;
receiving, from the external support information handling system, a request for access; and
in response to the request for access, transmitting an access token to the external support information handling system, wherein the access token is usable to remotely operate the target information handling system without transmission of account credentials to the external support information handling system.

8. The method of claim 7, wherein the information handling system is the target information handling system.

9. The method of claim 7, wherein the access token specifies the target information handling system as one of a plurality of potential target information handling systems.

10. The method of claim 7, wherein the access token specifies a period of time during which access is granted.

11. The method of claim 7, further comprising, in response to an indication that the remote operation of the target information handling system has ended, causing the access token to be revoked.

12. The method of claim 11, wherein remotely operating the target information handling system includes performing a task that requires administrator-level access to the target information handling system.

13. An article of manufacture comprising a non-transitory, computer-readable medium having computer-executable instructions thereon that are executable by a processor of an information handling system for providing access to a target information handling system by:
transmitting a request for support to an external support information handling system;
receiving, from the external support information handling system, a request for access; and
in response to the request for access, transmitting an access token to the external support information handling system, wherein the access token is usable to remotely operate the target information handling system without transmission of account credentials to the external support information handling system.

14. The article of claim 13, wherein the information handling system is the target information handling system.

15. The article of claim 13, wherein the access token specifies the target information handling system as one of a plurality of potential target information handling systems.

16. The article of claim 13, wherein the access token specifies a period of time during which access is granted.

17. The article of claim 13, wherein the instructions are further executable for, in response to an indication that the remote operation of the target information handling system has ended, causing the access token to be revoked.

18. The article of claim 17, wherein remotely operating the target information handling system includes performing a task that requires administrator-level access to the target information handling system.
